(19) United States
(12) Patent Application Publication
(10) Pub. No.: US 2003/0234244 A1
(43) Pub. Date: Dec. 25, 2003

(54) Multi-axis laser apparatus and process for the fine cutting of tubing

(76) Inventor: Edward D. McCoy, San Clemente, CA (US)

Correspondence Address: ALLEN D. BRUFSKY, P.A., 4140 GORDON DRIVE, NAPLES, FL, 34102, US

(21) Appl. No.: 10/395,606

(22) Filed: Mar. 24, 2003

Related U.S. Application Data
(62) Division of application No. 10/208,215, filed on Jul. 30, 2002.
(60) Provisional application No. 60/390,164, filed on Jun. 20, 2002.

(51) Int. Cl. B23K 26/38

(52) U.S. Cl. 219/121.72

(57) ABSTRACT

The present invention provides an improved system for producing metal stents with a fine precision structure cut from a small diameter, thin-walled, cylindrical tube. The tubes are fixtured under a laser and positioned utilizing a computer generated signal to move the tube in a very intricate and precise pattern around a linear and rotary axis. The stent is cut from small diameter tubing held between a collet and clamp, one of which is periodically opened and the other reciprocably moved to position a small length of tubing, sequentially beneath the cutting head. A water system is incorporated in the apparatus to remove debris falling into the interior of the cut tube and to push discrete portions of the cut tube (or stents) into a parts catcher to separate the stent from the uncut portion of the tube.

### CROSS-REFERENCE TO RELATED APPLICATION

This application claims priority from U.S. provisional application, Ser. No. 60/390,164, filed Jun. 20, 2002, which disclosure is incorporated herein by reference.

### BACKGROUND OF THE INVENTION

1. Field of the Invention

This invention relates to a method of and an apparatus for fine cutting tubing. More particularly, this invention is useful in manufacturing small, thin-walled, tubular devices known as stents, used in keeping coronary arteries open after an angioplasty procedure.

2. Description of the Prior Art

Coronary angioplasty is a medical procedure used to treat blocked coronary arteries as an alternative to a coronary bypass operation. It involves the insertion of a balloon catheter into the blocked artery and the inflation of the balloon to expand the size of the artery and relieve the blockage. While the procedure is often effective in opening the artery, one problem is the tendency of the artery to reclose. This requires that the angioplasty procedure be repeated which is obviously expensive and may be risky for the patient.

In recent years, small cylindrical tubes called stents have been inserted into the artery after a coronary angioplasty procedure. The stents are made of a thin-walled metallic material and have a pattern of apertures or holes cut around the circumference of the stent along most of its length. The purpose of the stent is to reinforce the walls of the artery after an angioplasty to prevent reclosing of the artery or to at least prolong the time the artery takes to reclose. The pattern in a stent is typically cut by a laser cutting tool.

In manufacturing stents, basic lathe techniques have been adapted to support the tubing used to form the stent during the hole cutting process. Typically, a piece of tubing is supported between a drive mechanism and a tail shock support in the manner of a lathe. A laser cutting tool positioned above the tubing will cut the pattern by moving relative to the tubing along the length of the finished stent, the tubing being rotated as necessary to present different parts of the circumference to the laser cutting tool. After the pattern is completely cut in the stent, the tubing is cut first at the tail stock end and then at the drive end of the individual stent to allow a finished stent to be completed.

Typical laser stent cutting methods and apparatus are shown in U.S. Pat. Nos. 6,369,355; 5,345,057; 5,780,807; 6,131,266 and 6,114,653. Typical expandable stents are shown in U.S. Pat. No. 6,344,055.

These manufacturing methods and apparatus have various limitations which results in a fairly high scrap rate. For example, because the pattern typically occupies a large percentage of the surface area of the stent, the stent may sag or bow downwardly during the cutting process as the pattern is cut and the cut area becomes larger. This is particularly true for thin walled material of the type most desirably used to form stents. In addition, friction from the tail stock mechanism often cause manufacturing errors throughout the part. Accordingly, many stents are rejected as failing to meet the necessary cut accuracy when manufactured by the methods and apparatus used prior to this invention.

Another difficulty is alignment of the drive mechanism and tail stock support with the laser cutting tool. These mechanisms are not directly coupled to one another. Accordingly, if any of the drive mechanism, tail stock support, or laser cutting tool are bumped or jarred during the manufacturing operation, further errors will occur. This is a further contributing factor to the relatively high scrap rate of these devices.

Typically, the tubing is advanced axially in one direction beneath the laser as sections are cut in their outer wall to form the stent pattern. Individual stents are then cut as indicated from a long length of the tubing, and as the pattern is cut in discrete lengths, sagging and bowing downwardly becomes more pronounced as the cut area becomes larger and heat is applied at the cut area to aid in the cutting process, as disclosed in the apparatus illustrated in the above patents.

One method proposed to obviate the problem was to support the workpiece at one end in a cantilever manner by a support fixture. The cutting tool is positioned past the end of the support fixture by a distance which is much less than the desired length of a finished workpiece. A first end of the stent is cut when that end first passes beneath the cutting tool and then the pattern is progressively cut as the tubing is advanced beneath the cutting tool, with the tubing being rotated as needed beneath the cutting tool to cut the pattern around the circumference of the tubing. However, because the distance between the cutting tool and the point of support for the tubing is relatively short in comparison to the length of the finished workpiece, the tubing does not sag or bow downwardly in this short distance, yielding improved accuracy and yield in the manufacturing method of this invention. However, the result was not completely satisfactory, as the tube could still bend, bow and sag at the juncture of the discrete stent portions being cut.

Alternatively, the prior art proposed inserting a second tube inside the stent tube. However, this necessited the use of an opening in the second tube to trap excess energy in the laser beam which was transmitted through the kerf so that it did not impinge on the opposed wall surface of the cut tube along with collecting debris ejected from the laser cut kerf, which required removal by vacuum or positive air pressure.

### SUMMARY OF THE INVENTION

The present invention provides an improved system for producing metal stents with a fine precision structure cut from a small diameter, thin-walled, cylindrical tube. The tubes are fixtured under a laser and positioned utilizing computer controls to generate a very intricate and precise pattern around an X, Y and Z-axis. Due to the thin-wall and the small geometry of the stent pattern, it is necessary to have very precise control of the laser, its power level, the focus spot size, and the precise positioning of the laser cutting path.

Therefore, in addition to the laser and the computer controlled positioning equipment, an optical delivery system is utilized in the practice of the present invention, and includes provision for a viewing head and focusing lens, and a coaxial gas jet that provides for the introduction of a gas stream that surrounds the focused beam and is directed along the beam axis. The coaxial gas jet nozzle is centered around the focused beam and pressurized with oxygen and is directed at the tube with the focused laser beam. The oxygen reacts with the metal to assist in the cutting process very similar to oxyacetylene cutting. The focused laser beam acts as an ignition source and controls the reaction of the oxygen with the metal. In this manner, it is possible to cut the material with a very fine kerf with precision.

However, unlike the prior art, the stent is cut from small diameter tubing held between a collet and a clamp, one of which is periodically opened and the other reciprocably moved to position a small length of tubing, sequentially beneath the cutting head. The laser beam is focused at the cutting head and the computerized program causes movement of the tube relative to the laser beam to cut the stent pattern in the tube walls.

The laser cutting beam is 0.0006-0.0008 inches in diameter and a camera arrangement enables visual adjustment and positioning of the beam relative to the tube; the tube being moved relative to the beam to effect precision cutting. As stated, the tubing is fed by reciprocal relative movement through a cutting block by a collet relative to the clamp, which positions a finite length of tubing beneath the beam. Oxygen is introduced at the cutting point of the focused beam to aid in the cutting process by enabling the tube material to be heated as it is cut. The pattern cut is controlled by movement of the tubing relative to the beam simultaneously along an X (length) and Y axis (rotary) controlled by a computerized encoder as part of a CNC positioning equipment. The encoder program is stored on a computer readable medium and has program code to effect movement of the tube relative to the beam. A horizontal laser beam enters a housing and is reflected off a mirror and focused by a micrometer actuated lens system through the collet to impinge on the tube to be cut. Gas (Oxygen) is pumped through the collet holding the tube at the beam entrance. A camera enables the operator to view the beam impinging on the tube as it is cut and to make adjustments to the cutting process, as necessary.

The motion imparted to the tube is engendered by a rotary and linear encoder mechanism directing linear and rotary motion which in response to input of coordinates on a computer, move the tube simultaneously along the X-Y axes to effect the requisite cut while in the cutting block, which is LED lighted so the cut can be readily viewed.

Further, a novel water system is incorporated in the apparatus at a convenient location to remove debris falling into the interior of the cut tube and to push discrete portions of the cut tube (or stents) into a parts catcher. The water also cools the cut stent and is recirculated for use. The water is pumped through the tube being cut and collet to entrain debris cut from the tube and push the cut tube portion from the collet into a parts catcher container. The water or fluid is recirculated, cleaned through the filters and recycled. Therefore, rather than use pressurized air or a vacuum, debris is removed by water circulated through the cut tubing.

The reciprocal motion between the collet and clamp enables a short length of the tube to be cut while being supported, preventing bowing and sagging of the tube during the cutting process.

### BRIEF DESCRIPTION OF THE DRAWINGS

Further objects and advantages of the invention will become more apparent from the following description and claims, and from the accompanying drawings, wherein:

FIG. 1 is a schematic block diagram which illustrates the components used in the practice of the invention.

FIG. 2 is a cross-sectional view of the cutting block component of the cutting block sub assembly of FIG. 1; and

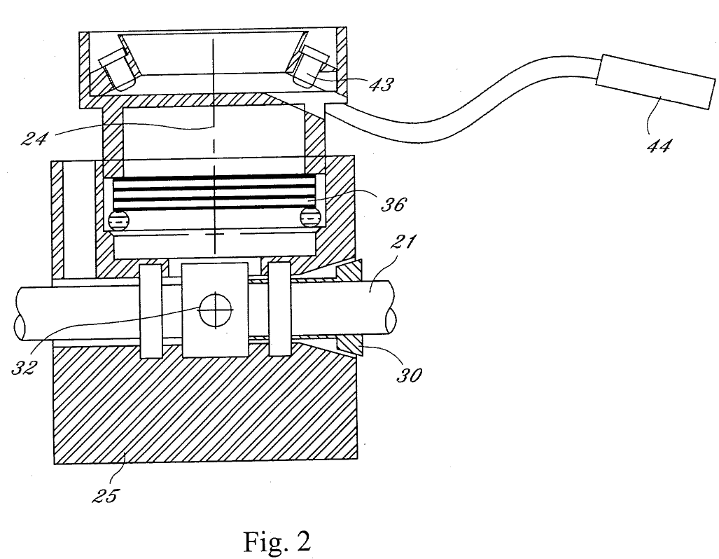

FIG. 3 is an exploded perspective view of the parts catcher subassembly of FIG. 1.

### DETAILED DESCRIPTION OF THE PREFERRED EMBODIMENT

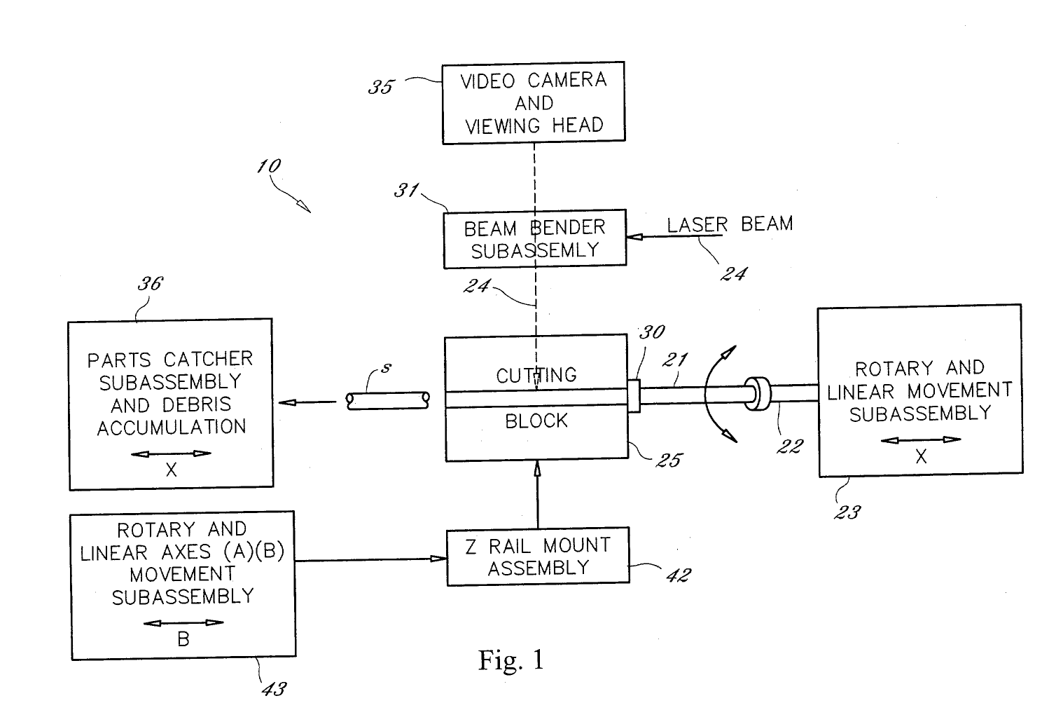

Referring now to the drawings in detail, wherein like numerals indicate like elements throughout the several views, there is shown in FIG. 1 the overall process and apparatus 10, in accordance with the invention, for producing metal stents S with a fine precision structure cut from a small diameter thin-walled cylindrical tube 21. Cutting a fine structure requires heat input and the ability to manipulate the tube 21 with precision. It is also necessary to support the tube 21, yet not allow the resultant stent structure S to distort during the cutting operation.

In order to successfully achieve the desired end results, the tubing 21 is put in a rotatable collet fixture 22 of a computer software controlled rotary and linear movement subassembly apparatus 23 for positioning the tubing 21 relative to a focused laser beam 24. According to encoded instructions, the tubing 21 is rotated and moved longitudinally relative to the laser beam 24. The laser beam 24 enters a collet fixture 22 on the cutting block subassembly 25 and cuts and selectively removes material from the tubing by ablation and a pattern is cut into the tubing 21. The tubing is thus cut into the discrete pattern of the finished stent S.

The process of cutting a pattern for the stent into the tubing 21 is automated except for loading and unloading the length of tubing 21. It may be done, for example, using computer operated software in conjunction with the opposed collet fixture 22 and a rotatable and linearly movable clamp mechanism 30 mounted on the cutting block subassembly 25 and a rotary and linear movement subassembly 23, respectively, enabling axial rotation of a length of the tubing, along with an X-axis table (not shown) driven by a computer controlled linear motor to move the length of tubing 21 axially relatively to laser beam 24, as described. A Z-rail mount subassembly 42 may be used to focus the laser beam 24 relative to focusing lenses 36 in cutting block subassembly 25 and to move into focus a video camera and viewing head 35 to spot the laser beam on the cut tubing 21. the cutting block subassembly can be provided with LEDs operated by a switch 44.

The entire space between collet 22 and clamp 30 can be patterned using the cutting laser of the foregoing example. The computer program for control of the rotary and linear movement subassembly apparatus 23 is dependent on the particular configuration used and the pattern to be ablated in the tubing 21.

The positioning of the tubing relative to the laser beam by the rotary and linear movement subassembly 23 requires the use of precision computer software operated equipment such as that manufactured and sold by Dr. Johanne's Heidenhain GmbH, D-83301, Trannrout Germany, having a rotary encoder mechanism for controlling the rotary movement of collet 22, through which one end of the tubing 21 is inserted. The unique rotary encoder mechanism allows the computer program to be written as if the pattern were being cut from a flat sheet which allows both circular and linear interpolation to be utilized in programming. The linear encoder mechanism and motor sold by RSF Electronik GmbH, A-5121, Tarsdorf, Germany positions the X-axis table against the spring force of a bellows (not shown) in accordance with the prescribed software program so that the combination of rotary (Y-axis) and linear (X-axis) movements of the tubing 21 relative to the cutting laser beam 24 cuts the precise stent pattern in a length of the tubing 21 moved in the X and Y direction relative to the beam.

Opposite the collet 22, the other end of the tubing 21 being cut is held within the radial clamp 30, which is periodically opened and closed in conjunction with the programmed advancement and retraction of tubing 21 by the table 25 along the X-axis to reposition an uncut, short portion of tubing 21 beneath cutting beam 24, assuring proper support to prevent distortion and sagging of the stent S as it is cut from the tubing 21.

An optical system comprising a beam bender subassembly 31 delivers and focuses the beam onto the surface of the tube 21 in a well-known manner.

A gas (oxygen) is injected through a nozzle 32 that helps to remove debris from the kerf formed in the tubing 21 and heats the region where the laser beam 24 interacts with the material as the beam cuts, and aids in vaporizing the metal.

A video camera and viewing head 35 along with a focusing lens 36 can be used to control the width of the beam and spot the beam to effect precision cutting.

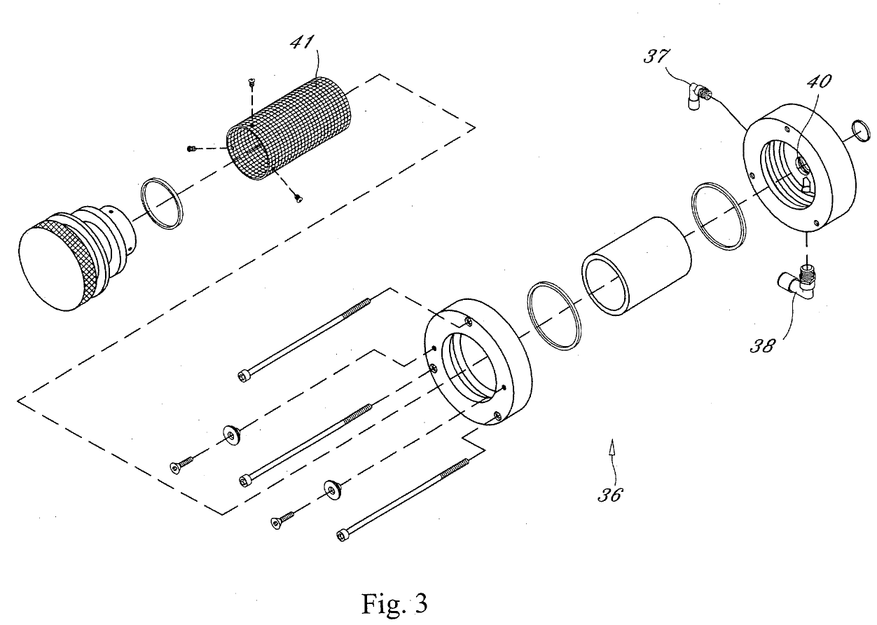

A circulating water system 36 having an inlet 37 and drain outlet 38 (FIG. 3) in a waterproof collar 39 which receives the cut stents S through an opening 40 is incorporated in the apparatus at a convenient location downstream from the cutting block subassembly 25. A parts catcher basket 41 receives debris falling into the interior of the cut tube 21 and pushed therefrom by the circulating water and discrete portions of the cut tube (or individual stents S) are caught by the parts catcher subassembly basket 41. The water or fluid is recirculated, cleaned through the filters (not shown) and recycled. The basket is periodically emptied to remove the cut stents S.

Therefore, rather than use pressurized air or a vacuum, debris is removed by water circulated through the cut tubing. The water also removes the cut tubing (stents) as soon as they are formed.

What is claimed is:

1. A method of producing a stent, comprising the steps of:
providing a tubular member having a working outer tube surface, an inner tube surface defining an inside diameter of the tubular member, and a tubular wall between the working outer tube surface and the inner tube surface;
impinging a focused laser beam on the working outer tube surface thereby causing the laser beam to cut through the tubular wall;
providing relative movement between the laser beam and the tubular member about a linear and rotary axis to cut a stent pattern, and
feeding a short length of an uncut portion of said tubular member supported at spaced points there along beneath said cutting laser beam while removing the previously cut portion as a patterned stent.

2. The method of claim 1 including the steps of flushing debris from interior of said cut tube while breaking off the cut stent from said uncut portion of said tubing by inserting a pressurized stream of water through said cut tubing at one end thereof.

3. The method of claim 2 including the steps of catching the cut stent after it is broken off by said stream of water impinging on said tubing.

4. The method of claim 1, wherein a gas jet stream is injected into substantially surrounding relation to the laser beam to aid in cutting said tubing.

5. A method of producing a stent, comprising the steps of:
providing a tubular member having a working outer tube surface, an inner tube surface defining an inside diameter of the tubular member, and a tubular wall between the working outer tube surface and the inner tube surface;
impinging a focused laser beam on the working outer tube surface thereby causing the laser beam to cut through the tubular wall; providing relative movement between the laser beam and the tubular member to cut a stent pattern, and sequentially feeding said tubular member beneath said cutting laser beam to position an uncut portion of said member beneath said beam while flushing debris from the inferior of said cut tubing and breaking off the cut stent from said tube, by inserting a pressurized stream of water through said tubing.

6. The method of claim 5 including the steps of catching the cut stent after it is broken off by said water stream impinging on said tubing.

7. The method of claim 5 wherein a gas jet stream substantially surrounds the laser beam where the beam impinges on the working outer tube surface to aid in cutting said tubing.

8. Multi-axis cutting apparatus comprising:
laser beam means for cutting a tube in a defined pattern, means for holding and moving said tube along a linear and rotary axis relative to said laser beam,
means for controlling the movement of said tube holding and movement means relative to said beam to cut a defined pattern in said tube, said holding and moving means including a collet and clamp for supporting a short length of said tubing beneath said cutting laser beam, said collet being directed by said controlling means to feed said tubing through said clamp after the tubing is cut and reciprocably return to its initial starting position to position an uncut portion of said tube beneath said laser cutting beam.

9. The cutting apparatus of claim 8 including means for removing a cut portion of said tube from the uncut portion while said uncut portion is being fed to a position beneath said laser cutting beam.

10. The cutting apparatus of claim 9 wherein said removal means includes means for breaking said cut portion of said tube from said uncut portion.

11. The cutting apparatus of claim 10 wherein means for breaking said cut portion of said tube from said uncut portion includes means for directing a stream of water through a cut in the wall of said tube and into the interior thereof to remove debris from the interior of the tube.

12. The cutting apparatus of claim 11 including means to catch the cut tube downstream from said breaking means.

13. The cutting apparatus of claim 12 including means to introduce a gas against said tube adjacent said laser cutting beam to in ablation of the wall of said tube.

14. A system for producing a stent comprising:
a laser device for cutting a tube in a definite pattern;
a positioning device configured to move said tube simultaneously along an X and Y axis relative to a laser beam to cut a defined pattern in said tube; and
an optical delivery system coupled to the positioning device for delivering and focusing the laser beam onto a surface of the tube where the focusing of the laser beam can be used to control a width of the laser beam for precision cutting of the tube.

15. A system comprising:
means for holding and moving a tube simultaneously along an X and Y axis relative to a laser beam; and
means for controlling movement of said tube, said holding and said moving means relative to said laser beam to cut a defined pattern in said tube, holding and moving means including a collet and clamp for supporting a short length of said tube beneath said laser cutting beam, said collet being directed by said controlling means to feed the tube through the clamp after the tubing is cut and reciprocably return to its initial starting position to position an uncut portion of said tube beneath said laser cutting beam.

16. A computer executable software stored on a computer readable medium comprising:
program code to control movement of a tube simultaneously along an X and Y axis relative to a laser beam to cut a defined pattern in said tube; and
program code to direct a collet to feed said tube through a clamp after the tubing is cut and reciprocably return to its initial starting position to position an uncut portion of said tube beneath said laser cutting beam.

17. A computer readable medium having codes stored thereon comprising:
program code that when executed will control movement of a tube simultaneously along an X and Y axis relative to a laser beam to cut a defined pattern in said tube; and
program code that when executed will direct a collet to feed said tubing through a clamp after the tubing is cut and reciprocably return to its initial starting position to position an uncut portion of said tube beneath said laser cutting beam.
